(19) United States
(12) Patent Application Publication
(10) Pub. No.: US 2017/0300621 A1
(43) Pub. Date: Oct. 19, 2017

(54) IMAGE REPORT ANNOTATION IDENTIFICATION

(71) Applicant: KONINKLIJKE PHILIPS N.V., EINDHOVEN (NL)

(72) Inventor: MICHAEL CHUN-CHIEH LEE, LEXINGTON, MA (US)

(21) Appl. No.: 15/508,169

(22) PCT Filed: Sep. 8, 2015
(86) PCT No.: PCT/IB2015/056866

§ 371 Date: Mar. 2, 2017

Related U.S. Application Data
(60) Provisional application No. 62/048,295, filed on Sep. 10, 2014.

(51) Int. Cl. G06F 19/00; G06F 17/30

(52) U.S. Cl. CPC G06F 19/321; G06F 17/30271; G06F 19/3487

(57) ABSTRACT

A method for creating a report with an annotation includes receiving an input image to annotate. The method further includes comparing the input image with a set of previously annotated images. The method further includes generating a similarity metric for each of the previously annotated images based on a result of a corresponding comparison. The method further includes identifying a previously annotated image with a greatest similarity for each of a plurality of predetermined annotations. The method further includes visually displaying the identified image for each annotation along with the annotation. The method further includes receiving an input signal identifying one of the displayed images. The method further includes annotating the input image with the identified one of the displayed images. The method further includes generating, in an electronic format, a report for the input image that includes the identified annotation.

### FIELD OF THE INVENTION

The following generally relates to determining an annotation for an electronically formatted image report based on previously annotated images.

### BACKGROUND OF THE INVENTION

Structured reporting is commonly used to capture descriptive information about tissue of interest (e.g., oncologic lesions) in medical imaging. With structured reporting, a radiologist labels tissue of interest in images using a standardized set of text annotations, which describe the tissue shape, orientation, location, and/or other characteristics in a manner that can be more easily interpreted by others who are familiar with the annotation nomenclature.

For example, in breast imaging, the Breast Imaging Reporting and Data System (BI-RADS) is a standard developed by the American College of Radiology. According to the standard, lesions evaluated on Mill should be described by shape (round, oval, lobular, irregular), margin (smooth, irregular, spiculated), enhancement (homogeneous, heterogeneous, rim enhancing, dark internal septation, enhancing internal septation, central enhancement), and other categories.

Similarly, in breast ultrasound, masses should be annotated as to their shape (oval, round, irregular), orientation (parallel, not parallel), margin (circumscribed, indistinct, angular, microlobulated, spiculated), and other categories. Similar systems exist or are being considered for other organs, such as lung. With such standards, a radiologist reviews the image and selects text annotations based on his or her observations and understanding of the definitions of the annotation terms.

A basic approach to structured reporting includes having a user directly select text annotations for an image or finding. This may be simply implemented as, e.g. a drop-down menu from which a user chooses a category via a mouse, touchscreen, keyboard, and/or other input device. However, such an approach is subject to the user's expertise and interpretation of the meaning of those terms. An alternative approach to structured reporting is visual reporting.

With visual reporting, the drop-down list of text is replaced with example images (canonical images) from a database, and the user selects annotations aided by example images. For example, instead of selecting just the term “spiculated”, the user may select an image showing example spiculated tissue from a group of predetermined fixed images. This reduces subjectivity because the definition of the structured annotation is given by the image rather than the textual term.

This visual image annotation aids in ensuring that all users have a common understanding of the terminology. However, the example images are fixed (i.e., the same canonical “spiculated” image is always shown), and there can be a wide variability in certain tissue such as lesions. As such, the canonical examples may not be visually similar to the current image. For example, even if the current patient image is “spiculated”, it may not sufficiently closely resemble the canonical “spiculated” image to be considered a match.

### SUMMARY OF THE INVENTION

Aspects described herein address the above-referenced problems and others. In one aspect, a method for creating an electronically formatted image report with a image annotation includes receiving an input image, of a patient, to annotate. The method further includes comparing the input image with a set of previously annotated images. The method further includes generating a similarity metric for each of the previously annotated images based on a result of a corresponding comparison. The method further includes identifying a previously annotated image with a greatest similarity for each of a plurality of predetermined annotations. The method further includes visually displaying the identified image for each annotation along with the annotation. The method further includes receiving an input signal identifying one of the displayed images. The method further includes annotating the input image with the identified one of the displayed images. The method further includes generating, in an electronic format, a report for the input image that includes the identified annotation.

In another aspect, a computing apparatus includes a first input device that receives an input image, of a patient, to annotate. The computing apparatus further includes a processor that compares the input image with a set of previously annotated images, generates a similarity metric for each of the previously annotated images based on a result of a corresponding comparison, and identifies a previously annotated image with a greatest similarity for each of a plurality of predetermined annotations. The computing apparatus further includes a display that visually displays the identified image for each annotation along with the annotation.

In another aspect, a computer readable storage medium encoded with computer readable instructions, which, when executed by a processer, causes the processor to: receive an input image, of a patient, to annotate, compare the input image with a set of previously annotated images, generate a similarity metric for each of the previously annotated images based on a result of a corresponding comparison, identify a previously annotated image with a greatest similarity for each of a plurality of predetermined annotations, visually display the identified image for each annotation along with the annotation, receive an input signal identifying one of the displayed images, annotate the input image with the identified one of the displayed images, and generate, in an electronic format, a report for the input image that includes the identified annotation.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an example computing system with a report module.

FIG. 2 schematically illustrates an example of report module.

FIG. 3 illustrates an example display showing best matched images for multiple different annotation types.

FIG. 4 illustrates an example method for generating a report with an annotation.

### DETAILED DESCRIPTION OF EMBODIMENTS

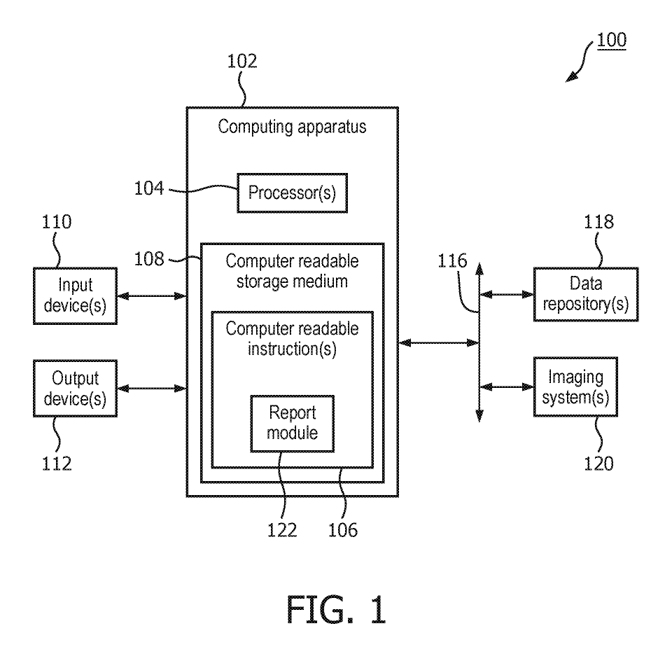

FIG. 1 illustrates a system 100 with a computing apparatus 102 that includes at least one processor 104, which executes one or more computer readable instructions 106 stored in computer readable storage medium 108, which excludes transitory medium and include physical memory and/or other non-transitory storage medium. The processor 104 can additionally or alternatively execute one or more computer readable instructions carried by a carrier wave, a signal or other transitory medium.

The computing apparatus 102 receives information from one or more input devices 110 such as a keyboard, a mouse, a touch screen, etc. and/or conveys information to one or more output devices 112 such as one or more display monitors. The illustrated computing apparatus 102 is also in communication with a network 116 and one or more devices in communication with the network such as at least one data repository 118, at least one imaging system 120, and/or one or more other devices.

Examples of data repositories 118 include, but are not limited to, a picture archiving and communication system (PACS), a radiology information system (RIS), a hospital information system (HIS), and an electronic medical record (EMR). Examples of imaging systems 120 include, but are not limited to, a computed tomography (CT) system, a magnetic resonance (MR) system, a positron emission tomography (PET) system, a single photon emission computed tomography (SPECT) system, an ultrasound (US) system, and an X-ray imaging system.

The computing apparatus 102 can be a general purpose computer or the like located at a physician's office, a health care facility, an imaging center, etc. The computing apparatus 102 at least includes software that allows authorized personnel to generate electronic medical reports. The computing apparatus 102 can convey and/or receive information using formats such as Health Level Seven (HL7), Extensible Markup Language (XML), Digital Imaging and Communications in Medicine (DICOM), and/or one or more other format(s).

The at least one computer readable instruction 106 includes a report module 122, which, when executed by the at least one processor 104 generates, in an electronic format, a report, for an input image to be annotated, that includes an annotation. As described in greater detail below, the report module 122 determines the annotation based on the input image to be annotated and a set of previously acquired and annotated images of other patients. In one instance, the final report includes an annotation corresponding to an image that visually matches tissue of interest in the input image better than a fixed example image with a generic representation of the tissue of interest.

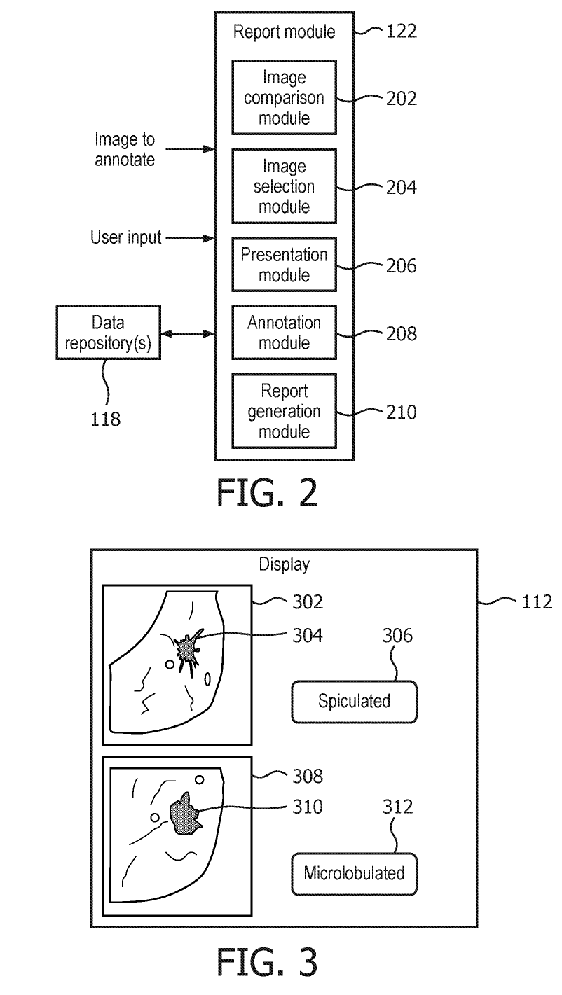

FIG. 2 schematically illustrates an example of the report module 122.

The report module 122 receives, as input, an image (of a subject or object) to be annotated. The input image can be from the imaging system(s) 120, the data repository(s) 118, and/or other device. In this example, the input image is a medical image, for example, a MRI, CT, ultrasound, mammography, x-ray, SPECT, or PET image. However, in a variation, the input image can be a non-medical image, such as an image of an object in connection with non-destructive testing, security screening (e.g., airport), and/or other non-medical application.

In this example, the report module 122 has access to the data repository(s) 118. It is to be appreciated that the report module 122 may have access to other data storage that stores previously acquired and annotated images, including cloud based storage, distributed storage, and/or other storage. The data repository(s) 118 includes, at least, a database of images of other patients for which annotations have already been created. Example image formats for such images include DICOM, JPG, PNG and/or other electronic image format.

In one instance, the data repository(s) 118 is a separately held curated database where images have been specifically reviewed for use in the application. In another instance, the data repository(s) 118 is a database past patients at a medical institution, for example, as stored in a PACS. Other data repositories are also contemplated herein. In this example, the data repository(s) 118 includes the image and the annotation. In another example, the image and the annotation are stored on separated devices.

Generally, the data repository(s) 118 includes at least one image representing each of the available annotations. For example, in one instance a set of available annotations includes margin annotations (e.g., “spiculated” or “circumscribed”), shape annotations (e.g., “round” or “irregular”), and/or one or more other annotations. For this set, the data repository(s) 118 includes at least one spiculated example image, at least one circumscribed example image, at least one round example image, and at least one irregular example image.

The report module 122 includes an image comparison module 202. The image comparison module 202 determines a similarity metric between the input image and one or more of the previously annotated images in the data repository(s) 118.

For the comparison, in one instance, the report module 122 receives a user input identifying a point or sub-region within the input image to identify tissue of interest in the input image to annotate. In another instance, the entire input image, rather than just the point or the sub-region of the input image, is to be annotated. In the later instance, the user input is not needed.

For the comparison, in one example, the identified portion or the entire two images (i.e., the input image and the previously annotated image) are compared. For this, the portion is first segmented using known and/or other approaches. Quantitative features are then computed using known and/or other approaches, generating numerical features descriptive of the size, position, brightness, contrast, shape, texture of the object and its surroundings, yielding a “feature vector”. The two feature vectors are then compared using, e.g. a Euclidean distance measure, with shorter distances representing more similar objects.

In another example, the images are compared in a pixel-wise (or voxel-wise, or sub-group of pixel or voxel-wise) approach such as sum-of-squared difference, mutual information, normalized mutual information, cross-correlation, etc. In the illustrated example, a single image comparison module (e.g., the image comparison module 202) performs all of the comparisons. In another example, there is a separate image comparison module for each annotation, at least one image comparison module for two or more comparisons and at least one other image comparison module for a different comparison, etc.

The report module 122 further includes an image selection module 204. The image selection module 204 selects a candidate image for each annotation.

In one instance, a single most similar image is selected. This can be done by identifying the image with a highest similarity measure and the requisite annotation. For example, where a lesion is described by margin (“spiculated” or “circumscribed”) and shape (“round” or “irregular”), the most similar “spiculated” lesion is identified, the most similar “circumscribed” lesion is identified, the most similar “round” lesion, and the most similar “irregular” lesion. There may be overlap, e.g. the most similar circumscribed lesion may also be the most similar round lesion.

In another instance, a set of similar images is identified where each set consists of at least one image. This may be achieved by selecting a subset of images (from the data repository(s) 118) with a given annotation where a similarity is greater than a pre-set threshold. Alternatively, this may be done by selecting a percentage of cases. For example, if similarity is measured on a 0-to-1 scale, with the above example, all spiculated lesions with a similarity greater than 0.8 may be chosen, or the 5% of spiculated lesions that have the highest similarity may be chosen. This is repeated for each annotation type.

The report module 122 further includes a presentation module 206. The presentation module 206 visually presents (e.g., via a display of the output device(s) 112) each annotation and at least one most similar image for each annotation. An example is shown in FIG. 3, which shows an image 302 with spiculated tissue 304 for the annotation spiculated 306, and an image 308 with microlobulated tissue 310 for the annotation microlobulated 312. In another instance, multiple images may be shown for an annotation. For example, instead of showing a single image representing the annotation “spiculated” 306 in FIG. 3, multiple images are shown for the annotation “spiculated” 306.

The report module 122 further includes an annotation module 208. The annotation module 208, in response to receiving a user input identifying one of the displayed images and/or annotations, annotates the input image with the displayed image. The visually presented images (e.g., FIG. 3) aid the user in selecting the correct annotation. The user can select an image, e.g. by clicking on a nearby button, clicking on the image, and/or similar operation.

The report module 122 further includes a report generation module 210. The report generation module 210 generates, in an electronic format, a report for the input image that includes the user selected annotation spiculated 306. In a variation, the report is a visual report, which further includes the identified annotated image 302 as a visual image annotation.

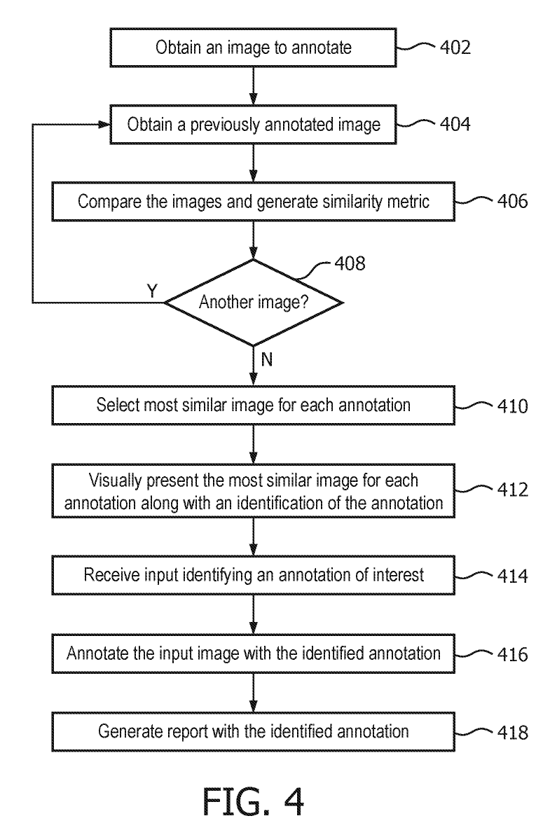

FIG. 4 illustrates an example flow chart in accordance with the disclosure herein.

It is to be appreciated that the ordering of the acts in the methods described herein is not limiting. As such, other orderings are contemplated herein. In addition, one or more acts may be omitted and/or one or more additional acts may be included.

At 402, an image to annotate is obtained.

At 404, a previously annotated image is obtained.

At 406, a similarity metric is determined between the two images.

At 408, it is determined if another previously annotated image is to be compared.

In response to there being another previously annotated image to compare, acts 404 through 408 are repeated.

At 410, in response to there not being another previously annotated image to compare, a most similar image is identified for each annotation based on the similarity metric.

At 412, the most similar previously annotated image for each annotation, along with an identification of the corresponding annotation, is visually presented.

At 414, an input indicative of a user identified previously annotated image and/or annotation is received.

At 416, the input image is annotated with the identified annotation.

At 418, a report, in electronic format, is generated for the input image with the identified annotation, and optionally, the identified image as a visual image annotation.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for creating an electronically formatted image report with an image annotation, comprising:
receiving an input image, of a patient, to annotate;
comparing the input image with a set of previously annotated images;
generating a similarity metric for each of the previously annotated images based on a result of the comparison of the input image with the respective previously generated image;
identifying, for each of a plurality of predetermined annotations, a previously annotated image with a greatest similarity to the input image based on the generated similarity matrix;
visually displaying the identified image for each of the plurality of annotations along with the annotation;
receiving an input signal identifying one of the displayed images;
annotating the input image with the annotation of the identified image; and
generating, in an electronic format, a report for the input image that includes the identified annotation.

2. The method of claim 1, further comprising:
identifying two or more previously annotated images for a predetermined annotation;
visually displaying the identified two or more previously annotated images for the annotation along with the annotation; and
receiving the input signal identifying one of the displayed images.

3. The method of claim 2, wherein the two or more previously annotated images each have a similarity greater than a predetermined threshold similarity level.

4. The method of claim 2, wherein the two or more previously annotated images each have a similarity in a predetermined percentage range of similarities.

5. The method of claim 1, wherein the set of previously annotated images includes previously annotated images for other patients.

6. The method of claim 1, wherein the set of previously annotated images includes at least one annotated image corresponding to each of the plurality of predetermined annotations.

7. The method of claim 1, wherein an entirety of the input image and an entirety of each image of the set of previously annotated images are compared.

8. The method of claim 7, wherein images are compared one of pixel-wise, voxel-wise, sub-group of pixel-wise, or sub-group of voxel-wise.

9. The method of claim 1, further comprising:
receiving a signal indicating a sub-region of the input image, wherein only the sub-region of the input image and a corresponding sub-region of each image of the set of previously annotated images is compared.

10. The method of claim 9, further comprising:
segmenting the sub-region of the input image and the corresponding sub-region of each image of the set of previously annotated images; and
comparing the segmented sub-region of the input image and the segmented sub-region of each image of the set of previously annotated images.

11. The method of claim 7, further comprising:
generating a quantitative feature vector for each of the input image and each image of the set of previously annotated images, wherein the comparison includes comparing the quantitative feature vectors.

12. The method of claim 11, wherein the quantitative feature vector includes numerical features descriptive of one of more of a size, a position, a brightness, a contrast, a shape, or a texture.

13. A computing apparatus, comprising:
a first input device that is configured to receive, an input image, of a patient, to annotate;
a processor that is configured to compares the input image with a set of previously annotated images, generates a similarity metric for each of the previously annotated images based on a result of the comparison of the input image with the respective previously annotated image, and identify, for each of a plurality of predetermined annotations, a previously annotated image with a greatest similarity to the input image based on the generated similarity matrix;
a display that is configured to visually displays the identified image for each of the plurality of annotations along with the annotation; and
a second input device that is configured to receive an input signal identifying one of the displayed images,
wherein the processor is further configured to annotate the input image with the identified one of the displayed images and generate, in an electronic format, a report for the input image that includes the identified annotation.

14. (canceled)

15. The computing apparatus of claim 13, wherein the processor is further configured to identify two or more previously annotated images for a predetermined annotation, and visually displays the identified two or more previously annotated images for the annotation along with the annotation.

16. (canceled)

17. (canceled)

18. (canceled)

19. (canceled)

20. A computer readable storage medium encoded with computer readable instructions, which, when executed by a processer, causes the processor to carry out the steps of the method defined in claim 1.
